(19) United States
(12) Patent Application Publication
(10) Pub. No.: US 2011/0233378 A1
(43) Pub. Date: Sep. 29, 2011

(54) DIE INSERTS FOR DIE CASTING

(76) Inventors: Daniel A. Bales, Avon, CT (US); Steven J. Bullied, Pomfret Center, CT (US); Carl R. Verner, Windsor, CT (US)

(21) Appl. No.: 12/730,498

(22) Filed: Mar. 24, 2010

(51) Int. Cl. B22C 9/00; B28B 7/00

(52) U.S. Cl. 249/142

(57) ABSTRACT

An apparatus for casting material has a die for receiving a compressive force, the die having a shaped-opening for receiving a die insert. The die insert has an exterior shape that is adapted to cooperate with and be received in the opening such that compressive forces impinging upon the die are focused upon the die insert such that tensile forces within the die and impinging upon the die insert are minimized.

### BACKGROUND

Investment casting is an industrial process based on one of the oldest metal forming techniques. This process is capable of producing complicated shapes that would be difficult or impossible (particularly with high melting temperature alloys) with die casting. Investment casting produces parts that usually require little surface finishing and only minor machining Usually, the process begins with fabrication of a sacrificial ceramic pattern with the same basic shape as the finished cast part. Patterns are made wax that is injected into a metal injection die. Fabricating the injection die is expensive and can take months of lead time.

Once a wax pattern is produced, it is then dipped in a ceramic slurry, covered with a particulate material, and allowed to dry. Once dried, the pattern is placed in an autoclave to remove the wax. After autoclaving, any remaining wax is burned out in a furnace during which the ceramic shell is also hardened. The mold is then preheated and filled with molten metal, creating the metal casting. Once the casting has cooled sufficiently, the mold shell is chipped away from the casting.

Die casting, on the other hand, is the process of forcing molten metal under high pressure into mold cavities that are machined into dies. Most die castings are made from nonferrous and relatively low melting temperature metals specifically zinc, copper, aluminum, magnesium, lead, and tin-based alloys, although ferrous metal die casts are possible. After the die is filled, and the material therein has solidified, the part for casting is ejected usually by ejector pins. Thereafter, any scrap, which includes gate runners and flash etc. must be separated from the castings.

The dies used in die casting are usually made out of hardest tool steels because cast iron cannot withstand the high pressures involved. Due to this, dies are expensive and may have high start-up costs.

### SUMMARY

According to an embodiment disclosed herein, an apparatus for casting material has a die for receiving a compressive force, the die having a shaped-opening for receiving a die insert. The die insert has an exterior shape that is adapted to cooperate with and be received in the opening such that compressive forces impinging upon the die are focused upon the die insert such that tensile forces within the die and impinging upon the die insert are minimized.

According to a feature of the embodiment, the die insert and the shaped opening have a plurality of shaped sides or a continuous side that compressive forces impinging upon the die are focused upon the die insert such that tensile forces within the die and impinging upon the die insert are minimized.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 is a side view of a die having a pair of inserts disclosed therein.

FIG. 2 is a further disclosure of the die inserts of FIG. 1 including top and side views of differently shaped dies and die inserts.

### DETAILED DESCRIPTION OF THE PREFERRED EMBODIMENT

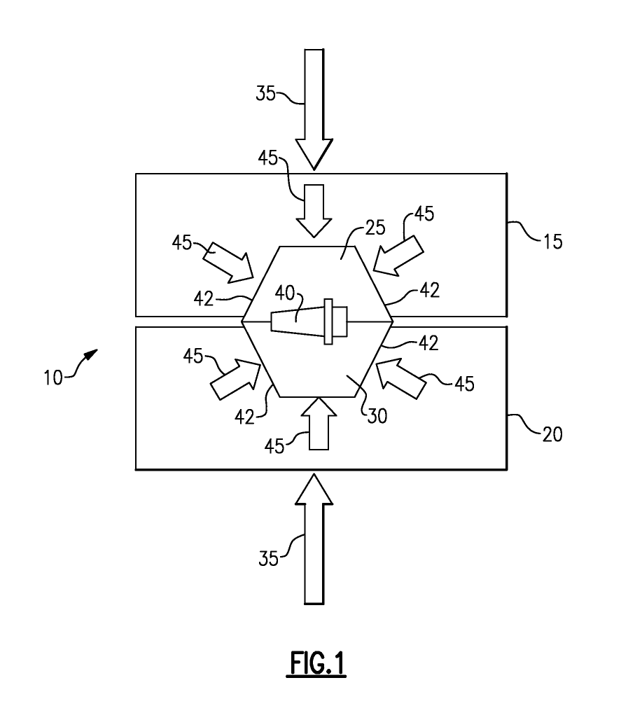

Referring now to FIG. 1 the embodiment of a die 10 is shown. The embodiment includes a top die 15, a bottom die 20, a top die insert 25, a bottom die insert 30. Both dies are driven by a press indicated by arrows 35 that supplies clamping forces that exert high pressure forces on the die inserts 25 and 30 as are known in the art. The use of 150 ton presses and greater are known to be used though lesser tonnage may be used depending on the size of a part 40 to be die cast.

In the instant application, the part 40 created by using the dies and die inserts is made of a high temperature nickel alloy that has a melting point around 2800° F.-2900° F. though other high temperature and low temperature alloys may be used herein. The die inserts are typically made of a ceramic material like silicon nitride which can withstand temperatures up to 5000° F. Silicon nitride has enviable properties like high strength over a wide temperature range, fracture toughness, high hardness, outstanding wear resistance, thermal shock resistance and chemical resistance. However other materials are known and are contemplated for use herein.

The upper and lower die inserts 25, 30 fit very snuggly within the upper and lower dies 15, 20 and have tapered or contoured sides 42 so that operation of the presses force the top die and the bottom die to provide the uniform compressive forces indicated by arrows 45 upon the upper and lower die inserts 25, 30. Ceramic materials, like silicon nitride, have very low ductility and compressive forces are ideally tolerated by the material while tensile forces are not as well tolerated. By providing the uniform compressive force caused by the contoured sides on the die inserts, which focus the compressive forces on the upper and lower die inserts 25, 30, any tensile forces, which might damage the die inserts 15, 20, on the die inserts are minimized and die life is therefore maximized.

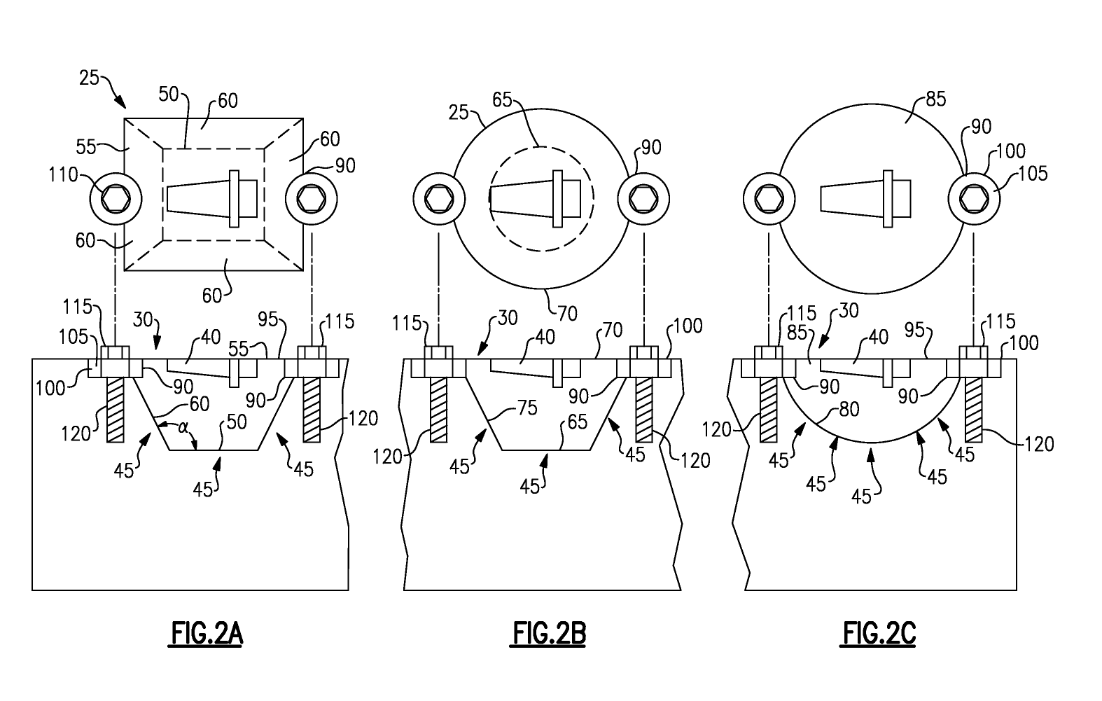

Referring now to FIG. 2, several alternative embodiments of the die inserts 2A, 2B and 2C a side view of lower die 20 and lower die insert 30, and a bottom view of the top die insert 25 are shown.

In FIG. 2A, the upper die insert 25 has a rectangular top portion 50, a rectangular bottom portion 55 and four angled side surfaces 60 that attach the top portion 50 to the bottom portion 55. Similarly, the lower die insert 30 mirrors the upper die insert 25.

In FIG. 2B, upper die insert has a circular top portion 65, a circular bottom portion 70 and a conical side surface 75 joining the top portion 65 to the bottom portion 70 so that the die looks like a truncated cone. Similarly, the lower die insert 30 mirrors the upper die insert 25.

In FIG. 2C, upper die insert has a bowl-shaped top and side portion 80 and a circular face portion 85 so that the die looks like a bowl. Similarly, the lower die insert 30 mirrors the upper die insert 25.

Ideally the side surface forms an angle a that is greater than 90° between the side surface 60 and the top surface 50 (see FIG. 2A).

Each upper and lower die insert in FIGS. 2A, 2B, and 2C have a pair of shoulders 90 in a mating surface 95 thereof and a side surface 60, 75, 80 thereof so that a screw 100 will mate with the top surface and the side surface to hold the upper and lower die insert 25, 30 in the upper and lower dies 15, 20 respectively.

Screw 100 has a large head 105 in which a counter sink 110 is disposed therein. In the embodiment shown, the counter sink 110 is hexagonally-shaped to receive a hexagonally-shaped pin 115 that locates the upper die 15 atop the lower die 20. The screws mate with holes 120 within the upper and lower dies 15, 20.

Alternatively, the pins 115 may be set or manufactured within the screw 105 so that one screw 105 disposed in the bottom die 20 would, for instance, mate with the screw counter sink 110 in the upper die 15 or vice-versa. Other locating devices and other shaped countersinks are contemplated for use herein.

In operation, the upper die insert 25 is inserted into a top die 15 and a bottom die insert 30 is placed in the bottom die 20. The inserts are secured to the dies by screws 100 that fit into holes 120 and the enlarged screw head 100 holds the shoulders 90 of the upper and lower die inserts 25, 30 securely in the upper and lower dies 15, 20. The top die insert and the bottom die insert are then aligned via the pins 115 that are inserted into countersinks 110. Liquid metal is then injected at high temperature between the dies into the die cavity to create a part 40.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. An apparatus for casting material, said apparatus comprising:
a die for receiving an exterior compressive force, said compressive force molding a part, and having a shaped-opening for receiving a die insert, and
a die insert having an exterior shape that is adapted to cooperate with and be received in said opening such that compressive forces impinging upon said die are focused upon said die insert such that tensile forces within said die and impinging upon said die insert are minimized.

2. The apparatus of claim 1 wherein said exterior shape of said die insert is angled from a surface away from a mating surface thereof and/or towards a mating surface thereof.

3. The apparatus of claim 2 wherein said angle is greater than 90°.

4. The apparatus of claim 1 wherein said die insert is constructed of a ceramic material.

5. The apparatus of claim 4 wherein said ceramic material is silicon nitride.

6. The apparatus of claim 1 wherein said die is adapted for use with parts made of a high temperature nickel alloy.

7. The apparatus of claim 1 wherein said die insert has a shoulder for holding said die insert within said die.

8. The apparatus of claim 7 further comprising a fastener impinging upon said shoulder and attaching to said die for holding said die insert within said die.

9. The apparatus of claim 8 wherein said fastener is a screw having a head resting on said shoulder and a body anchored to said die.

10. The apparatus of claim 1 wherein said exterior shape of said die insert and shaped-opening of said die are analogous.

11. The apparatus of claim 10 wherein said exterior shape of said die insert and shaped-opening of said die are identical.

12. The apparatus of claim 1 wherein parts made in said die insert are for use in jet engines.

13. The apparatus of claim 9 wherein said screw head has an indentation for receiving a second screw head aligned in an adjacent second die.
